(19) United States
(12) Patent Application Publication
(10) Pub. No.: US 2011/0142415 A1
(43) Pub. Date: Jun. 16, 2011

(54) DIGITAL CONTENT AND APPARATUS AND METHOD FOR REPRODUCING THE DIGITAL CONTENT

(75) Inventor: Sung-Ryeul RHYU, Yongin-si (KR)

(73) Assignee: Samsung Electronics Co., Ltd., Gyeonggi-do (KR)

(21) Appl. No.: 12/966,544

(22) Filed: Dec. 13, 2010

(30) Foreign Application Priority Data
Dec. 11, 2009 (KR) 10-2009-0123286

(51) Int. Cl. H04N 5/92

(52) U.S. Cl. 386/245; 386/E05.026

(57) ABSTRACT

Disclosed is a digital content, and an apparatus and a method for reproducing a digital content. The method includes reading and reproducing the digital content, determining whether it is possible to display a text subtitle included in the digital content by an embedded font, if so, outputting the text subtitle by using the embedded font, and if not, converting the text subtitle to one subtitle among one or more different subtitles having a different file type corresponding to the text subtitle and outputting the converted subtitle. The method can select and output an optimum subtitle according to various standards and thus can be flexibly operated in consideration of the performance of the reproduction apparatus and the situation of the digital contents.

### PRIORITY

This application claims priority under 35 U.S.C. §119(a) to an application entitled “Digital Content And Apparatus And Method For Reproducing The Digital Content” filed in the Korean Industrial Property Office on Dec. 11, 2009 and assigned Serial No. 10-2010-0123286, the contents of which are incorporated herein by reference.

### BACKGROUND OF THE INVENTION

1. Field of the Invention

The present invention relates generally to digital content and an apparatus for reproducing the digital content, and more particularly, to digital content and an apparatus for reproducing the digital content, which supports multiple types of subtitles.

2. Description of the Related Art

Movies and music are generally distributed as digital contents. Such digital contents are provided by optical recording mediums such as a Digital Video Disc and a Blu-ray disc, and Internet provider services such as Pay Per View (PPV), Rental, and Electronic Sell Through (EST), and a movie, music file, or bell sound.

Such digital contents typically include a set including one or more files, which is called a container, a package, or a file format. The container includes an eXtensible Markup Language (XML) tag, a Mime type, or a bitmap field, in order to indicate what types of digital contents are included in a corresponding container. The types of digital contents include, but are not limited to, video data containing visual information, audio data containing auditory information, subtitle data containing subtitles or captions, additional meta data, additional resources for additional meta data, and graphic resources indicating an interactive menu or pop-up information.

A digital content reproduction apparatus accesses a container, identifies whether such information as described above is included in the container, and displays proper information according to a user's instruction or a preset promise so that the user can enjoy the digital contents.

In most cases, digital contents and a reproduction apparatus for the digital contents support subtitles, which serve as an auxiliary means for enjoying the digital contents. Although a native speaker may not use a subtitle reproduction function, the subtitle reproduction function may be an indispensable function for a user, who is not a native speaker or has limited hearing. Further, in order to enable a user to enjoy digital contents including a foreign language, digital contents should include subtitles made in various languages and a reproduction apparatus thereof should be capable of reproducing the digital contents including the multi-language subtitles.

Subtitles are generally classified into picture subtitles and text subtitles. The picture subtitles correspond to subtitles made and stored in the form of pictures. There are various methods of displaying pictures, which include a method of displaying image subtitles without change and a method of displaying image subtitles in multiple stages, such as two stages including stage 0 and stage 1, four stages including stage 00, stage 01, stage 10, and stage 11, or more than four stages.

According to the method of displaying image subtitles in multiple stages, pixels or dots in a region of a screen are colored based on palette information corresponding to the stage values. The text subtitles correspond to subtitles made and stored in the form of a text, which is expressed by methods such as American Standard Code for Information Interchange (ASCII) and Unicode. When a text is expressed by the Unicode, it can be expressed by Unicode Transformation Format (UTF) 8, 16, 32, etc. Therefore, either the used expression method may be indicated by Byte Order Mark (BOM) or a standardized and promised method may be used for the storage and reproduction of the text while omitting the BOM. Even the Unicode may include a remark for the language since American English and British English are different.

The text subtitles are converted from text to a picture by using font files embedded together with the text subtitles, and the display quality of the subtitles is determined according to the performance of a reproduction apparatus and the preference of users. High quality display of subtitles is very time and power-consuming.

FIG. 1 illustrates a digital content 110, a reproduction apparatus 120 for the digital content, and a display apparatus 130 according to the prior art.

As shown in FIG. 1, the reproduction apparatus 120 includes a processor 121, a memory 122, a converter 123, and a decoder 124. The digital content 110 includes a video file 111, an audio file 112, a picture subtitle 113, a text subtitle 114, and a font 115. The digital content 110 may include either one of or both of the text subtitle 114 and the picture subtitle 113.

The picture subtitle 113 can exhibit a predetermined quality according to the intention of the content producer regardless of the system performance. However, the picture subtitle 113 may cause the problem of breaking due to layout or resizing in a screen having a different resolution. Therefore, the picture subtitle 113 is used in a system having a limited resolution level.

The text subtitle 114 can be expressed with a flexible layout in various resolutions. However, the quality of the text subtitle 114 is determined based on a proper level rather than the best quality, in consideration of the gap between the processing power required for the high quality and the Consumer Electronics (CE) products having a limited performance. Further, the text includes complicated vector graphic data within the font file in order to output vivid characters. In the case of Chinese, Japanese, or Korean (CJK) language, the font file generally includes more than ten thousand Glyphs. While a usual English font file has a size of about 150 KB, a CJK font file has a size of at least 4 MB, up to about 10 MB. Therefore, it is difficult to include the font file in each contents or download and reproduce the font file whenever the contents are reproduced.

Moreover, in order to search such an enormous quantity of database information, find a character font proper for the corresponding text, and then convert the font, additional resources such as processing power and memory are necessary.

### SUMMARY OF THE INVENTION

Accordingly, the present invention has been made to solve the above-mentioned problems occurring in the prior art, and an aspect of the present invention provides a digital content, which includes both a text subtitle and a picture subtitle and can selectively display an optimum subtitle from the two types of subtitles, and a reproduction apparatus of the digital content.

In accordance with an aspect of the present invention, there is provided a digital content for displaying an image, the digital content including a video file and an audio file corresponding to the image, a text subtitle corresponding to the video file and the audio file, and at least one different subtitle, which corresponds to the video file and the audio file, includes a substance corresponding to the text subtitle, and has a file type different from that of the text subtitle.

In accordance with another aspect of the present invention, there is provided an apparatus for reproducing a digital content, the apparatus including a processor for reading the digital content and displaying the read digital contents through a display unit, an embedded font for displaying a text subtitle included in the digital content in a language used in a predetermined country, and a converter for converting the text subtitle to one subtitle among one or more different subtitles having a different file type corresponding to the text subtitle when it is impossible to display the text subtitle by the embedded font.

In accordance with another aspect of the present invention, there is provided a method of reproducing a digital content, the method including reading and reproducing the digital content, determining whether it is possible to display a text subtitle included in the digital content by an embedded font, when it is possible to display the text subtitle by the embedded font, outputting the text subtitle by using the embedded font, and when it is not possible to display at least a part of the text subtitle by the embedded font, converting the text subtitle to one subtitle among one or more different subtitles having a different file type corresponding to the text subtitle and outputting the converted subtitle.

### BRIEF DESCRIPTION OF THE DRAWINGS

The above and other aspects, features and advantages of the present invention will be more apparent from the following detailed description taken in conjunction with the accompanying drawings, in which:

FIG. 1 illustrates a digital content and a reproduction apparatus for the digital content according to the prior art;

FIG. 2 illustrates a digital content and a reproduction apparatus for the digital content according to an embodiment of the present invention;

FIG. 3 illustrates subtitles of digital contents according to a first embodiment of the present invention;

FIG. 4 illustrates subtitles of digital contents according to a second embodiment of the present invention; and

FIG. 5 illustrates an operation of reproducing digital contents by a reproduction apparatus according to an embodiment of the present invention.

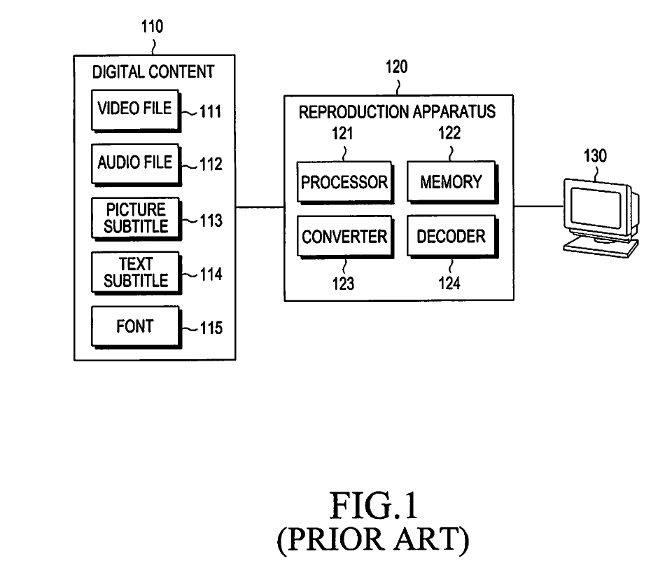

### DETAILED DESCRIPTION OF EMBODIMENTS OF THE PRESENT INVENTION

Hereinafter, embodiments of the present invention will be described with reference to the accompanying drawings. In the following description, a detailed description of known functions and configurations incorporated herein will be omitted when it may make the subject matter of the present invention rather unclear. Further, various specific definitions found in the following description, such as specific values of packet identifications and contents of displayed information, are provided only to help general understanding of the present invention, and it will be apparent to those skilled in the art that the present invention can be implemented without such definitions.

The present invention provides a digital content including a text subtitle and a picture subtitle, which can be displayed at a time point, and another type of subtitle. The present invention discloses a reproduction method, which basically expresses a text subtitle by a reproduction apparatus equipped with a font file including only indispensable data, and replaces the text subtitle by a second or a third context when there is a text subtitle that cannot be expressed by the fonts included in the reproduction apparatus.

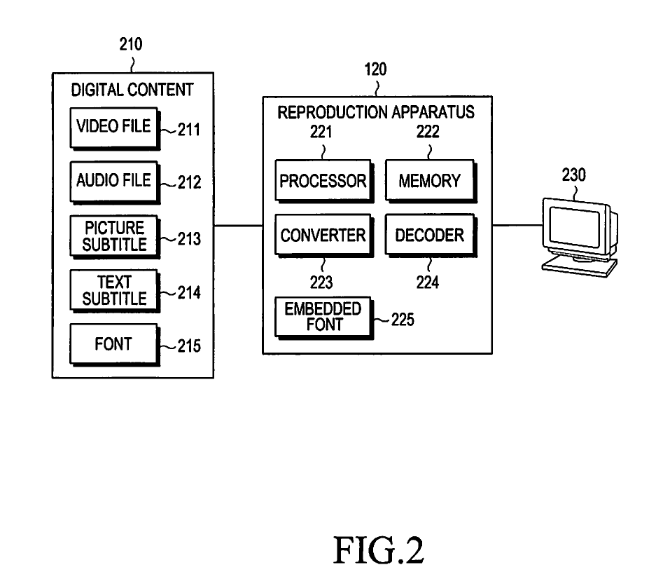

FIG. 2 illustrates a digital content 210, and a reproduction apparatus 220 and a display apparatus 230 for the digital contents according to an embodiment of the present invention.

As shown in FIG. 2, the digital content 210 includes a video file 211, an audio file 212, a picture subtitle 213, a text subtitle 214, and a font 215.

The reproduction apparatus 220 includes a processor 221, a memory 222, a converter 223, a decoder 224, and an embedded font 225. A digital content reproduction apparatus generally has characteristics specific to the area in which the apparatus is sold. Therefore, the digital content reproduction apparatus may be equipped with fonts including only letter scripts for expressing the characters in the language predominantly used where the apparatus is sold. For example, characters used in France include ç, which is not included in English. Thus, ç is generally not used in England or in the US. In consideration of such a circumstance, it is more advantageous for a digital content reproduction apparatus to be equipped with fonts 225 specific to the area, in which the apparatus is sold, within the apparatus as shown in FIG. 2, than to be equipped with all fonts capable of all the characters over the world.

Hereinafter, digital contents and a method of reproducing the contents according to an embodiment of the present invention will be described in detail.

First, a content provider inserts subtitles in a container of digital contents or contents to be additionally bound and reproduced. The subtitles of digital contents may have a form of text, picture, or dynamic image.

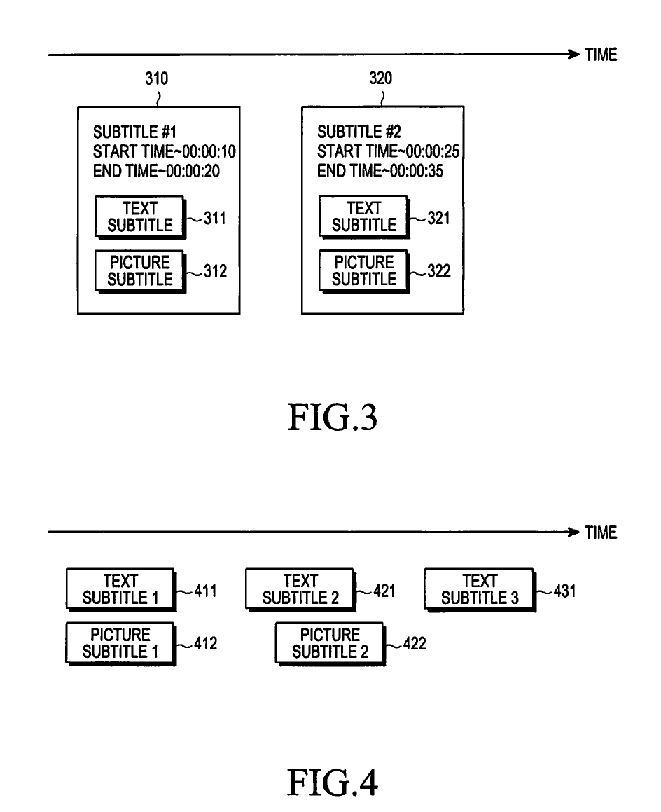

FIGS. 3 and 4 illustrate subtitles of digital contents according to first and second embodiments, respectively, of the present invention.

As shown in FIG. 3, a text subtitle 311 or 321 and a picture subtitle 312 or 322 may be included in one subtitle file 310 or 320 of digital contents. Otherwise, as shown in FIG. 4, each of text subtitles 411, 421, and 431 and picture subtitles 412 and 422 may be configured as a separate subtitle file.

The reproduction times of the text and picture subtitles included in each subtitle file 310 or 320 may coincide with each other as shown in FIG. 3, or the reproduction times of the text and picture subtitles for the same video and audio file may not completely coincide with each other as shown in FIG. 4.

Further, a video and audio file at a certain time point may include only one of a text subtitle and a picture subtitle. The file indicated by reference numeral 431 includes only a text subtitle without a picture subtitle.

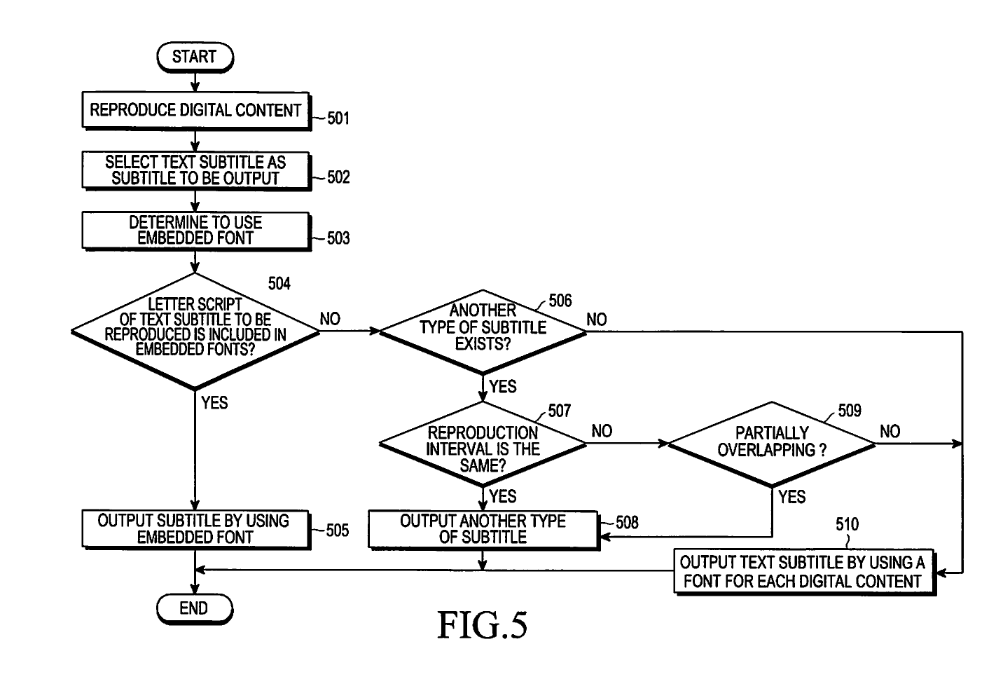

FIG. 5 illustrates an operation of reproducing digital contents by a reproduction apparatus according to an embodiment of the present invention.

Referring to FIG. 5, in step 501, the apparatus for reproducing digital contents starts to reproduce digital contents by reading the digital contents, in order to output a corresponding subtitle at a corresponding time point at which the corresponding subtitle exists. Before outputting a subtitle, the reproduction apparatus determines the type of the subtitle to be output, that is, determines whether to output a text subtitle, a picture subtitle, or another type of subtitle, in consideration of the resolution, a user's preference, or the intention of the content provider, in step 502.

When the reproduction apparatus has determined to output a text subtitle, the reproduction apparatus determines a font (among embedded fonts) to be used by reading an embedded font file in step 503. That is, the reproduction apparatus determines whether it will not use a font file included in a container or a font file additionally downloaded and bound to be reproduced.

When use of an embedded font has been determined, the reproduction apparatus determines whether the letter script of the text subtitle to be reproduced is included in the embedded fonts in step 504. This determination may be performed either for the text subtitles of all the digital contents or for an individual subtitle at a time point of preparing the individual subtitle. Further, it can be performed at a proper time point determined by a separate process or thread.

After completing the determination on whether an embedded font supporting the text subtitle exists, when it is possible to display all characters of the text subtitle by using the embedded font, the reproduction apparatus outputs the subtitle by using the embedded font in step 505. However, when it is not possible to display some or all characters of the text subtitle by using the embedded font, the reproduction apparatus determines whether another type of subtitle, such as a picture subtitle, corresponding to the corresponding text subtitle exists (step 506).

When another type of subtitle corresponding to the text subtitle exists, the reproduction apparatus determines whether the reproduction interval of the new type of subtitle is the same as that of the text subtitle in step 507. When the reproduction interval is the same, the reproduction apparatus outputs the subtitle in step 508. If another type of subtitle having the same reproduction interval as that of the corresponding text subtitle exists and is a picture subtitle as shown in FIG. 3, the picture subtitle is output in place of the part of the text subtitle, at which some or all characters thereof cannot be supported by the embedded fonts.

When the reproduction interval of the another type of subtitle corresponding to the text subtitle is not the same as that of the text subtitle, the reproduction apparatus determines whether the reproduction interval of the new type of subtitle partially overlaps with that of the text subtitle in step 509. When the reproduction intervals partially overlap with each other, the reproduction apparatus outputs the subtitle of the overlapping portion in step 508. That is, when the reproduction intervals of the text subtitle and the picture subtitle do not completely coincide with each other but partially overlap with each other, the picture subtitle is displayed according to the reproduction time of the picture subtitle. In this case, no subtitle is displayed in the period in which the reproduction intervals of the text subtitle and the picture subtitle do not overlap with each other, while a picture subtitle is displayed in the period in which the reproduction intervals of the text subtitle and the picture subtitle overlap with each other.

Further, the substance of the picture subtitle is substantially the same as the substance of the text subtitle, for the viewer's convenience. It is possible to calculate the difference between the reproduction times of the text subtitle and the picture subtitle and adjust the reproduction start time of the picture subtitle so that the picture subtitle is reproduced according to the reproduction time of the text subtitle.

When another type of subtitle having the same reproduction interval as that of the corresponding text subtitle exists but the reproduction interval does not overlap, or when another type of subtitle corresponding to the text subtitle does not exist as noted from text subtitle 431 of FIG. 4, the reproduction apparatus determines to use a font embedded in a container or a font additionally downloaded to be bound in step 510. Among the subtitles, information such as the time for downloading the font, the size of the font, the portion occupied by a subtitle at one time point within the entire subtitles, and the portion that cannot be supported by the embedded fonts and does not have a picture subtitle, can be considered in determining whether to use a font embedded in a container or a font additionally downloaded to be bound.

When another type of subtitle corresponding to the text subtitle does not exist and the reproduction apparatus has determined to use a font embedded in a container, the reproduction apparatus may send information about the embedded fonts of the reproduction apparatus and the fonts included in the container to a server in order to inquire whether their styles are similar. The font can be converted based on each character. Therefore, if styles of the embedded fonts and the fonts included in the container are similar, a font included in the container may be used for a character within the text subtitle, which cannot be supported by the embedded fonts, while an embedded font may be used for a character within the text subtitle, which can be supported by the embedded fonts, in displaying the text subtitle.

According to another embodiment of the present invention, before or during the reproduction of digital contents, the reproduction apparatus may determine whether the embedded fonts include all characters of the entire text subtitle. As a result of the determination, when the text subtitle includes a character that is not included in the embedded fonts, the reproduction apparatus may determine a correlation between the text subtitle (1^{st} subtitle) including the character and another type of subtitle (2^{nd} subtitle) corresponding to the text subtitle. When there is any 30 coinciding or same portion between the substance of the 1^{st} subtitle and the substance of the 2^{nd} subtitle, the reproduction apparatus determines that the 1^{st} subtitle can be replaced by the 2^{nd} subtitle, and outputs the 2^{nd} subtitle.

Hereinafter, advantages of the present invention will be briefly described.

According to the present invention, it is possible to display an optimum subtitle for various resolutions. Further, a reproduction apparatus can select and contain advantageous fonts for displaying the text subtitle according to its use environment, can display the text subtitle by using the selected fonts, and can display a subtitle by using a second or third same identical context included in the digital contents when the text subtitle is not provided. In addition, a digital content reproduction apparatus according to the present invention can select and output an optimum subtitle among various types of subtitles according to various preset standards and thus can be flexibly operated in consideration of the performance of the reproduction apparatus and the situation of the digital contents.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A digital content for displaying an image, the digital content comprising:
a video file and an audio file corresponding to the image;
a text subtitle corresponding to the video file and the audio file; and
at least one different subtitle, different from the text subtitle, which corresponds to the video file and the audio file, includes a substance corresponding to the text subtitle, and has a file type different from that of the text subtitle.

2. The digital content of claim 1, wherein the different subtitle is a subtitle made in a picture file.

3. The digital content of claim 1, wherein the text subtitle and the different subtitle have a coinciding reproduction interval or reproduction intervals at least partially coinciding with each other.

4. An apparatus for reproducing a digital content, the apparatus comprising:
a processor for reading the digital content and displaying the read digital contents through a display unit;
an embedded font for displaying a text subtitle included in the digital content in a language predominantly used in a country; and
a converter for converting the text subtitle to one subtitle among one or more different subtitles having a different file type corresponding to the text subtitle when it is not possible to display the text subtitle by the embedded font.

5. The apparatus of claim 4, wherein, when it is not possible to display the text subtitle by the embedded font, the converter converts the text subtitle to a subtitle, which is included in the digital content and has an identical or at least partially overlapping reproduction interval with that of the text subtitle, among said one or more different subtitles.

6. The apparatus of claim 5, wherein, at a time point of outputting a character, which is included in the text subtitle but cannot be displayed by the embedded font, the converter converts the character to one subtitle among said one or more different subtitles.

7. The apparatus of claim 4, wherein, when it is not possible to display the text subtitle by the embedded font and the digital content does not include one or more different subtitles having a different file type corresponding to the text subtitle, the processor displays the text subtitle by using a font included in the digital content.

8. A method of reproducing a digital content, the method comprising:
reading and reproducing the digital content;
determining whether it is possible to display a text subtitle included in the digital content by an embedded font;
when it is possible to display the text subtitle by the embedded font, outputting the text subtitle by using the embedded font; and
when it is not possible to display at least a part of the text subtitle by the embedded font, converting the text subtitle to one subtitle among one or more different subtitles having a different file type corresponding to the text subtitle and outputting the converted subtitle.

9. The method of claim 8, wherein, in converting the text subtitle, when it is not possible to display the text subtitle by the embedded font, the text subtitle is converted to a subtitle, which is included in the digital content and has an at least partially overlapping reproduction interval with that of the text subtitle, among said one or more different subtitles.

10. The method of claim 9, wherein, in converting the text subtitle, at a time point of outputting a character, which is included in the text subtitle but cannot be displayed by the embedded font, the character is converted to one subtitle among said one or more different subtitles.

11. The method of claim 8, wherein, in converting the text subtitle, when it is not possible to display the text subtitle by the embedded font and the digital content does not include one or more different subtitles having a different file type corresponding to the text subtitle, the text subtitle is displayed by using a font included in the digital content.
